(19) United States
(12) Patent Application Publication
(10) Pub. No.: US 2015/0303000 A1
(43) Pub. Date: Oct. 22, 2015

(54) LITHIUM ION CAPACITOR, POWER STORAGE DEVICE, POWER STORAGE SYSTEM

(71) Applicant: SUMITOMO ELECTRIC INDUSTRIES, LTD., Osaka-shi, Osaka (JP)

(72) Inventors: Kazuki Okuno, Osaka-shi (JP); Kengo Goto, Osaka-shi (JP); Koutarou Kimura, Osaka-shi (JP); Hajime Ota, Osaka-shi (JP); Junichi Nishimura, Osaka-shi (JP); Akihisa Hosoe, Osaka-shi (JP)

(21) Appl. No.: 14/350,996

(22) PCT Filed: Oct. 3, 2012
(86) PCT No.: PCT/JP2012/075629

§ 371 Date: Apr. 10, 2014

(30) Foreign Application Priority Data
Oct. 12, 2011 (JP) 2011-224502

(51) Int. Cl. H01G 11/38; H01G 11/68; H01G 11/56; H01G 11/06; H01G 11/24

(52) U.S. Cl. CPC H01G 11/38; H01G 11/06; H01G 11/24; H01G 11/56; H01G 11/68

(57) ABSTRACT

By producing a positive electrode having a large capacity commensurate with the negative electrode capacity, a lithium ion capacitor having an increased capacity can be provided. A lithium ion capacitor includes a positive electrode including a positive electrode active material mainly composed of activated carbon and a positive electrode current collector, a negative electrode including a negative electrode active material capable of occluding and desorbing lithium ions and a negative electrode current collector, and a nonaqueous electrolyte containing a lithium salt, in which the positive electrode current collector is an aluminum porous body having a three-dimensional structure, the positive electrode active material is filled into the positive electrode current collector, and the negative electrode current collector is a metal foil or a metal porous body.

### TECHNICAL FIELD

The present invention relates to a lithium ion capacitor having an increased capacity, a power storage device in which a plurality of such capacitors are assembled into a composite device, and a power storage system in which the capacitor is combined with an inverter, a reactor, or the like to constitute a composite system.

### BACKGROUND ART

With environmental problems being highlighted, power storage devices have been actively developed as storage systems for clean energy, for example, by solar power generation and wind power generation, as backup power sources for computers and the like, and as power sources for hybrid vehicles, electric cars, and the like.

As such power storage devices, lithium ion secondary batteries (LIBs) and electric double-layer capacitors (EDLCs) are known.

However, in recent years, lithium ion capacitors (LICs) have been receiving attention as power storage devices having a large capacity in which advantages of lithium ion secondary batteries (LIBs) and advantages of electric double-layer capacitors (EDLCs) are combined.

That is, in the case of a lithium ion battery (LIB), for example, a cell is constructed using a positive electrode in which a layer containing a positive electrode active material such as lithium cobalt oxide (LiCoO₂) powder is disposed on an aluminum (Al) current collector, a negative electrode in which a layer containing a negative electrode active material such as graphite powder capable of occluding and desorbing lithium ions is disposed on a copper (Cu) current collector, and a nonaqueous electrolyte composed of a lithium salt such as LiPF₆ and an organic solvent such as ethylene carbonate (EC) or diethyl carbonate (DEC) (refer to FIG. 2). It is possible to obtain a voltage of 2.5 to 4.2 V, and the LIB has a high energy density. However, it is difficult to operate the LIB under a high current density, and the output density thereof is not high.

On the other hand, in the case of an electric double-layer capacitor (EDLC), for example, a cell is constructed using a positive electrode and a negative electrode, in each of which a layer containing activated carbon serving as an active material is disposed on an Al current collector, and an electrolyte composed of (C₂H₅)₄NBF₄ or the like and an organic solvent such as propylene carbonate (PC) (refer to FIG. 3). The EDLC has a high output density. However, the voltage obtained is 0 to 3 V, and the energy density of the EDLC is not high.

In contrast, a cell of a lithium ion capacitor (LIC) is constructed using a positive electrode in which a layer containing activated carbon as an active material is disposed on an Al current collector, which is used as the positive electrode of the EDLC; a negative electrode in which a layer containing a negative electrode active material such as graphite powder capable of occluding and desorbing lithium ions is disposed on a copper (Cu) current collector, which is used as the negative electrode of the LIB; and a nonaqueous electrolyte which is composed of a lithium salt such as LiPF₆ and an organic solvent such as EC or DEC, which is used as the electrolyte of the LIB (refer to FIG. 4).

The positive electrode, the negative electrode, and a separator of the cell are alternately stacked and inserted into a case, and the electrolyte is poured thereinto. Then, lithium ions are generated from a lithium ion source (lithium metal or the like) which has been enclosed in the case in advance, and the negative electrode active material is caused to occlude (to be predoped with) the lithium ions by a chemical or electrochemical method. Thereby, an LIC is fabricated. In the LIC thus fabricated, it is possible to obtain a voltage of 2.5 to 4.2 V and a high energy density as in the LIB, and it is also possible to obtain a high output density as in the EDLC.

However, the positive electrode of an existing LIC is generally produced by a method in which after a conductive aid such as acetylene black and a binder such as polytetrafluoroethylene are mixed into activated carbon, which is a positive electrode active material, a solvent such as N-methyl-2-pyrrolidone is added thereto to form a positive electrode active material paste, and the paste is applied onto an Al foil to form an active material layer on the Al foil (for example, Patent Literature 1). Therefore, it is difficult to increase the positive electrode capacity (the capacity of the positive electrode per unit area).

That is, since the binder, which is an insulator, is used in the production of the positive electrode, when the thickness of the active material layer is increased, the electrical resistance increases at a distance from the current collector (Al foil), and the supply of electrons to the active material decreases. As a result, because of the charge balance, the amount of adsorption of charge on the surface of the active material at a distance from the current collector decreases.

Since the amount of adsorption of charge decreases, the actual amount of charge accumulated in the positive electrode decreases. Therefore, the positive electrode capacity decreases, and also the utilization ratio (amount of charge actually accumulated/theoretical value of amount of accumulation of charge calculated from the amount of the active material filled) decreases.

Consequently, in existing LICs, usually, the negative electrode capacity (capacity of the negative electrode per unit area) is overwhelmingly larger than, i.e., about 10 times, the positive electrode capacity, and the positive electrode capacity restricts the capacity of the LICs. This is causing problems for further increasing the capacity of LICs, which has been strongly desired recently.

### CITATION LIST

### Patent Literature

PTL 1: Japanese Unexamined Patent Application Publication No. 2001-143702

### SUMMARY OF INVENTION

### Technical Problem

The present invention has been achieved in view of the problems described above. It is an object of the present invention to provide a lithium ion capacitor (LIC) having an increased capacity by producing a positive electrode having a large capacity commensurate with the negative electrode capacity.

### Solution to Problem

In order to solve the problems, the present inventors have considered that, when a porous body is used as a positive electrode current collector instead of the conventional foil, the filling density can be increased by also filling pore portions with an active material, and thus the capacity of the positive electrode can be increased, and have conducted various experiments and studies. As a result, it has been found that, when an Al porous body having a three-dimensional structure is used, a noticeable effect is exerted on the reduction of electrical resistance in the active material layer of the positive electrode, and thus the present invention has been completed. Note that the term “three-dimensional structure” refers to a structure in which a constituent material, for example, Al rods or Al fibers, in the case of Al, are three-dimensionally interconnected with each other to form a network.

That is, first, the present inventors have studied Al porous bodies mechanically formed, such as punched metals and lath. However, since these materials have a substantially two-dimensional structure, the filling density of the active material cannot be sufficiently increased, and it is not possible to anticipate a large improvement in the capacity. Furthermore, they have low mechanical strength and are easy to break, which is also a problem.

While conducting further studies, the present inventors have focused on a method employed in producing nickel metal hydride batteries, specifically, a method of obtaining an electrode in which a Ni porous body having a three-dimensional structure is used as a current collector, pores are filled with an active material slurry, followed by pressing, so as to increase the filling density and decrease the distance between the active material powder particles and the Ni porous body, and have studied employment of Al porous bodies having a three-dimensional structure.

As a result, it has been confirmed that, although Ni cannot withstand a voltage of 4.2 V and becomes melted, Al can withstand a voltage of 4.2 V and can be used as a positive electrode current collector.

It has also been confirmed that, in the case of use of the Al porous body, during predoping, unlike the case where a foil is used, Li⁺ can easily move without using a special device.

Furthermore, the present inventors have confirmed, as will be described later, that in the case where lithium titanium oxide (LTO) is used as a negative electrode active material, the Al porous body can also be used as a negative electrode current collector, and that in the case where silicon (Si) or a tin-base material is used as a negative electrode active material, a Ni porous body can be used as a negative electrode current collector. By using such an Al porous body as a negative electrode current collector, the weight of the LIC can be reduced.

The present invention has been achieved on the basis of the findings described above. A lithium ion capacitor according to the present invention has the following characteristics.

(1) A lithium ion capacitor according to the present invention includes a positive electrode including a positive electrode active material mainly composed of activated carbon and a positive electrode current collector, a negative electrode including a negative electrode active material capable of occluding and desorbing lithium ions and a negative electrode current collector, and a nonaqueous electrolyte containing a lithium salt, characterized in that the positive electrode current collector is an aluminum porous body having a three-dimensional structure, the positive electrode active material is filled into the positive electrode current collector, and the negative electrode current collector is a metal foil or a metal porous body.

Next, the present inventors have studied preferred embodiments of the Al porous body described above. As a result, it has been found that, in the case of an Al porous body having a three-dimensional structure in which the coating weight (Al weight at a thickness of 1 mm at the time of production) is 80 to 1,000 g/m² and the pore diameter (cell diameter) is 50 to 1,000 since the filling density of the active material can be sufficiently increased and a sufficient mechanical strength is exhibited, it is possible to produce a positive electrode having a large capacity commensurate with the negative electrode capacity, and the Al porous body can be suitably used as a positive electrode current collector of an LIC. When the pore diameter is less than 50 μM, filling of the active material, which plays a key role in the battery reaction, cannot be performed smoothly. On the other hand, when the pore diameter is more than 1,000 the effect of retaining the active material in the structure of the porous body is small, resulting in a decrease in output and shelf life. Regarding the pore diameter (cell diameter), a surface of a porous body is magnified using microphotography or the like, the number of pores per 1 inch (25.4 mm) is calculated as the number of cells, and the average value is obtained from the expression: average cell diameter=25.4 mm/number of cells.

Furthermore, as described above, the Al porous body having a three-dimensional structure can also be used as a negative electrode current collector.

As a method for producing such an Al porous body, many methods have been proposed, and examples thereof include a method in which Al powder is sintered to obtain an Al porous body, a method in which a nonwoven fabric is subjected to Al plating, and then the nonwoven fabric is removed by performing heat treatment, to thereby obtain an Al porous body, and a method in which a resin foam is subjected to Al plating, and then the resin is removed by performing heat treatment, to thereby obtain an Al porous body. Among these methods, it is preferable to use the method in which a resin foam or nonwoven fabric is subjected to Al plating, and then the resin foam or nonwoven fabric is removed by performing heat treatment, to thereby obtain an Al porous body.

That is, in the method in which Al powder is sintered to obtain an Al porous body, there is a possibility that titanium (Ti) as an impurity will be mixed during sintering. In the Al porous body into which Ti is mixed, voltage endurance decreases. Therefore, the Al porous body is not suitable as a positive electrode current collector.

However, in the method in which a resin foam or nonwoven fabric is subjected to Al plating, and the heat treatment is performed, such a problem does not occur, which is preferable.

Among these methods, in the case where a urethane foam is used as the resin foam, unlike the case where a nonwoven fabric is used, there is no possibility that an Al porous body having poor surface flatness will be produced because of thickness variation occurring in the Al porous body due to the thickness variation of the nonwoven fabric, which is particularly preferable.

On the basis of the findings described above, the lithium iron capacitor according to the present invention further has the following characteristics.

(2) The lithium ion capacitor according to (1), characterized in that the positive electrode current collector is an aluminum porous body having a three-dimensional structure in which the coating weight is 80 to 1,000 g/m² and the pore diameter (cell diameter) is 50 to 1,000 μm.

Furthermore, the lithium iron capacitor according to the present invention has the following characteristics.

(3) The lithium ion capacitor according to (1) or (2), characterized in that the negative electrode active material is mainly composed of a carbon material.

(4) The lithium ion capacitor according to (3), characterized in that the carbon material is any one of graphite, graphitizable carbon, and non-graphitizable carbon.

(5) The lithium ion capacitor according to (1) or (2), characterized in that the negative electrode active material is mainly composed of any one of silicon, tin, and lithium titanium oxide.

(6) The lithium ion capacitor according to any one of (1) to (5), characterized in that the negative electrode current collector is composed of any one of aluminum, copper, nickel, and stainless steel.

(7) The lithium ion capacitor according to any one of (1) to (6), characterized in that the lithium salt is at least one selected from the group consisting of LiClO₄, LiBF₄, and LiPF₆; and a solvent of the nonaqueous electrolyte is at least one selected from the group consisting of ethylene carbonate, propylene carbonate, butylene carbonate, dimethyl carbonate, diethyl carbonate, and ethyl methyl carbonate.

(8) The lithium ion capacitor according to any one of (1) to (7), characterized in that the capacity of the negative electrode per unit area (negative electrode capacity) is larger than the capacity of the positive electrode per unit area (positive electrode capacity), and the amount of lithium ions occluded in the negative electrode active material is 90% or less of the difference between the positive electrode capacity and the negative electrode capacity.

The LIC obtained as described above has a sufficiently increased capacity. Therefore, by assembling a plurality of LICs in series and/or in parallel into a composite device, it is possible to provide an excellent power storage device. Furthermore, by combining the LIC with an inverter and a reactor to constitute a composite system, it is possible to provide an excellent power storage system.

(9) A power storage device according to the present invention is characterized in that a plurality of lithium ion capacitors, each being the lithium ion capacitor according to any one of (1) to (8), are assembled in series and/or in parallel into a composite device.

(10) A power storage system according to the present invention is characterized in that the lithium ion capacitor according to any one of (1) to (8) is combined with an inverter and/or a reactor to constitute a composite system.

### Advantageous Effects of Invention

According to the present invention, it is possible to produce a positive electrode having a large capacity commensurate with the negative electrode capacity, and it is possible to provide a lithium ion capacitor (LIC) having an increased capacity.

### BRIEF DESCRIPTION OF DRAWINGS

FIG. 1A is one of a series of views illustrating an example of a production process of an Al porous body in the present invention and is an enlarged schematic view showing a part of the cross section of a resin foam having interconnecting pores.

FIG. 1B is one of a series of views illustrating an example of a production process of an Al porous body in the present invention and is an enlarged schematic view showing a part of the cross section of an Al-coated resin foam in which an Al layer is formed on the surface of the resin foam.

FIG. 1C is one of a series of views illustrating an example of a production process of an Al porous body in the present invention and is an enlarged schematic view showing a part of the cross section of an Al porous body formed by decomposing the resin foam so as to leave only the Al layer.

FIG. 2 is a view illustrating a structure of a cell of a lithium ion battery.

FIG. 3 is a view illustrating a structure of a cell of an electric double-layer capacitor.

FIG. 4 is a view illustrating a structure of a cell of a lithium ion capacitor.

### DESCRIPTION OF EMBODIMENTS

The present invention will be specifically described below on the basis of embodiments.

1. Positive Electrode

(1) General Description

A positive electrode of a lithium ion capacitor (LIC) according to the present invention is produced by filling an Al porous body with a positive electrode active material mainly composed of activated carbon. In the present application, the expression “mainly composed of” means that the relevant substance is contained in an amount of more than 50% by weight. The expression “mainly composed of activated carbon” means that activated carbon is contained in an amount of more than 50% by weight.

When the Al porous body, which is a current collector, is filled with a positive electrode active material, the filling amount (content) is not particularly limited, and may be appropriately selected depending on the thickness of the current collector, the shape of the LIC, and the like. For example, the filling amount is preferably about 13 to 40 mg/cm², and more preferably about 16 to 32 mg/cm².

As the method of filling the positive electrode active material, for example, a method may be used in which activated carbon etc. are formed into a paste, and the activated carbon positive electrode paste is filled by a known process, such as an injection process. Other examples include a method in which a current collector is immersed in an activated carbon positive electrode paste, and as necessary, pressure reduction is performed; and a method in which filling is performed by spraying an activated carbon positive electrode paste from one side onto a current collector while applying a pressure using a pump or the like.

In the positive electrode, after being filled with the activated carbon paste, as necessary, the solvent in the paste may be removed by drying treatment. Furthermore, as necessary, after being filled with the activated carbon paste, compression forming may be performed by pressing with a roller press or the like.

By performing compression forming, the activated carbon paste can be filled at a higher density, and the thickness of the positive electrode can be adjusted to a desired thickness. Regarding the thickness before and after compression, the thickness is preferably usually about 300 to 5,000 μm before compression and usually about 150 to 3,000 μM after compression forming, and more preferably about 400 to 1,500 μM before compression and about 200 to 800 μm after compression forming.

Furthermore, a lead terminal may be provided on the electrode. The lead terminal can be attached by welding or application of a conductive adhesive.

(2) Positive Electrode Current Collector

As the positive electrode current collector, an Al porous body having a coating weight, which the weight of Al when the thickness of the positive electrode current collector at the time of production is 1 mm, of 80 to 1,000 g/m² and a pore diameter of 50 to 1,000 μm is preferably used.

Such an Al porous body has excellent current-collecting performance because the Al skeleton having high electrical conductivity and excellent voltage endurance is present continuously therein. Furthermore, since the Al porous body has a structure in which activated carbon (active material) is encapsulated in the vacant space of the porous body, the content ratios of a binder, a conductive aid, and the like can be decreased, and the filling density of activated carbon (active material) can be increased. Consequently, the internal resistance can be decreased, and the capacity can be increased. The thickness of the positive electrode current collector is usually preferably about 150 to 3,000 μm in terms of average thickness, and more preferably about 200 to 800 μm.

Such an Al porous body can be obtained by forming an Al coating layer on the surface of a resin foam or nonwoven fabric, and then removing the resin or nonwoven fabric, which is a substrate. For example, it can be produced by the method described below.

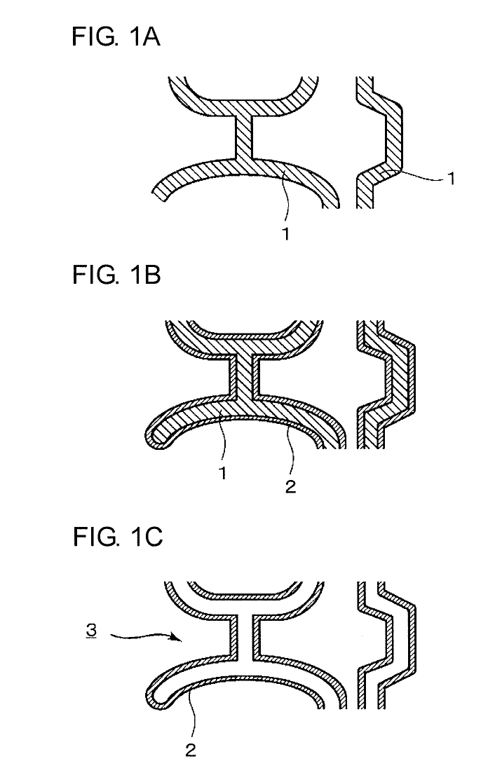

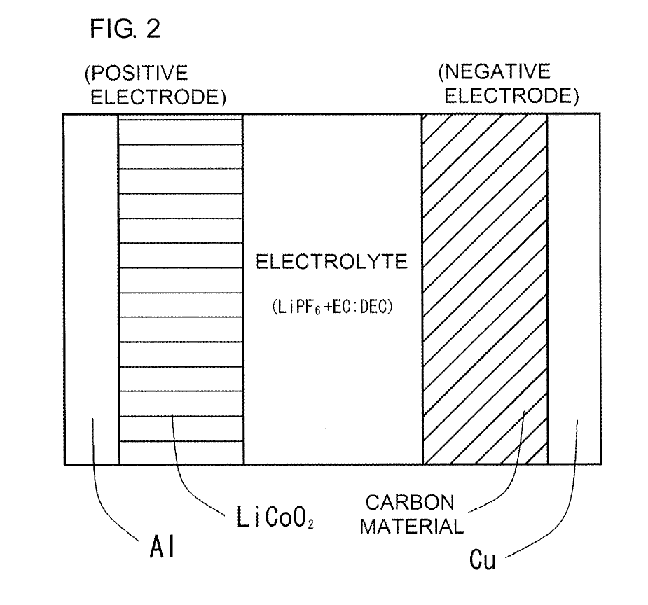

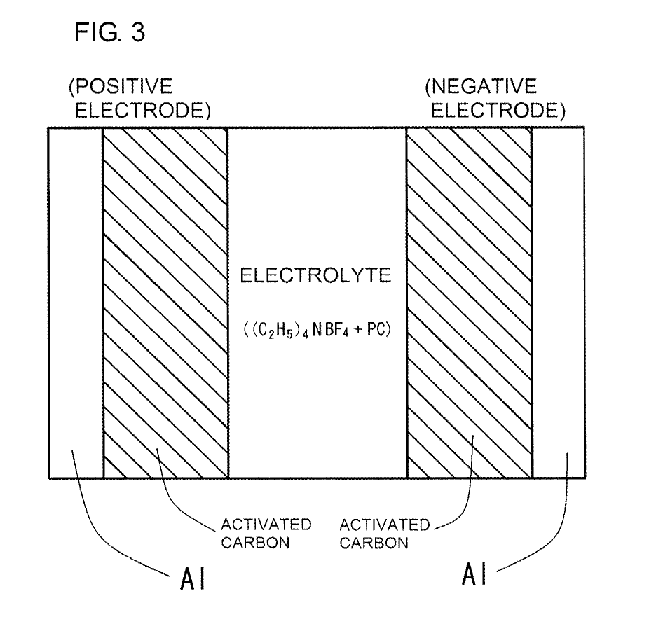

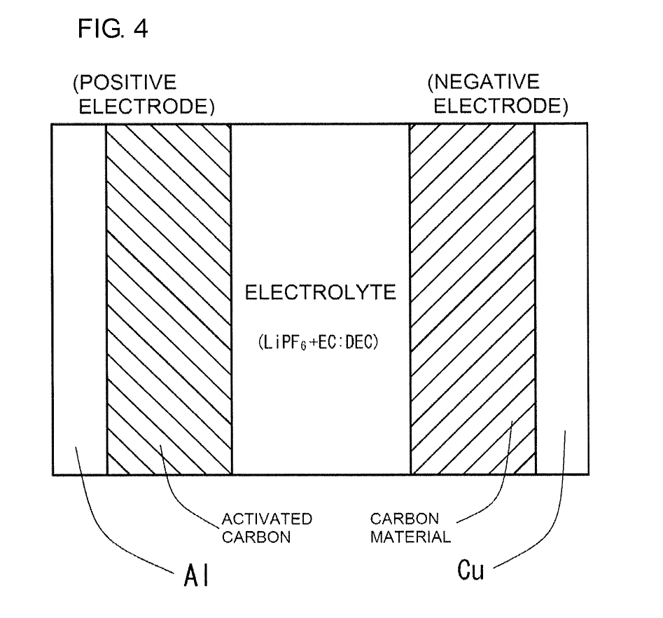

FIGS. 1A, 1B, and 1C are schematic views illustrating an example of a method for producing an Al porous body. FIG. 1A is an enlarged schematic view showing a part of the cross section of a resin foam having interconnecting pores, in which pores are formed with a resin foam 1 serving as a skeleton.

First, a resin foam 1 having interconnecting pores is prepared, and by forming an Al layer 2 on the surface thereof, an Al-coated resin foam is obtained (FIG. 1B).

The resin foam 1 is not particularly limited as long as it is porous, and a urethane foam, a styrene foam, or the like can be used. A resin foam, with a porosity of 40% to 98%, having interconnecting pores with a cell diameter of 50 to 1,000 μm is preferably used. Among these, a urethane foam, which has a high porosity (80% to 98%), high uniformity in cell diameter, and excellent heat decomposability, is particularly preferable.

The Al layer 2 can be formed on the surface of the resin foam 1 by any method, for example, a gas-phase method, such as vapor deposition, sputtering, or plasma CVD, application of an aluminum paste, or a molten salt electrolytic plating method.

Among these methods, a molten salt electrolytic plating method is preferable. In the molten salt electrolytic plating method, for example, using an AlCl₃—XCl (X: alkali metal) binary salt system or multicomponent salt system, the resin foam 1 is immersed in the molten salt, and by applying a potential, electrolytic plating is performed to form an Al layer 2. In this process, conductivity-imparting treatment is performed in advance on the surface of the resin foam 1, using a method, such as vapor deposition or sputtering of Al or the like, or application of a conductive coating material containing carbon or the like.

Furthermore, when the Al layer 2 is formed, it is necessary to prevent impurities, such as Ni, Fe, Cu, and Si, from being incorporated into the Al layer 2. In the case where a positive electrode containing these impurities is used, the impurities may be dissolved out and deposited onto the negative electrode during charging, resulting in short-circuiting.

Next, the Al-coated resin foam is immersed in a molten salt, and a negative potential is applied to the Al layer 2. This can inhibit the Al layer 2 from being oxidized. In this state, by heating at a temperature that is equal to or higher than the decomposition temperature of the resin foam 1 and equal to or lower than the melting point of Al (660° C.), the resin foam 1 is decomposed and the Al layer 2 only remains. Thus, an Al porous body 3 can be obtained (FIG. 1C).

The heating temperature is preferably 500° C. to 650° C.

As the molten salt, a halide salt of an alkali metal or alkaline earth metal can be used so that the electrode potential of the Al layer becomes base. Specifically, preferably, the molten salt contains one or more selected from the group consisting of lithium chloride (LiCl), potassium chloride (KCl), sodium chloride (NaCl), and aluminum chloride (AlCl₃). A eutectic molten salt obtained by mixing two or more of the above salts to decrease the melting point is more preferable.

(3) Activated Carbon (Positive Electrode Active Material) Paste

The activated carbon paste is obtained, for example, by adding activated carbon powder into a solvent and stirring with a mixer. As long as the activated carbon paste contains activated carbon and a solvent, the mixing ratio thereof is not limited. As the solvent, for example, N-methyl-2-pyrrolidone, water, or the like may be used.

In particular, in the case where polyvinylidene fluoride is used as a binder, N-methyl-2-pyrrolidone may be used as the solvent, and in the case where polytetrafluoroethylene, polyvinyl alcohol, carboxymethylcellulose, or the like is used as a binder, water may be used as the solvent. Furthermore, as necessary, additives, such as a conductive aid and a binder, may be incorporated therein.

(a) Activated Carbon

As the activated carbon, activated carbon commercially available for use in electric double-layer capacitors can be used in the same manner. Examples of raw materials for activated carbon include wood, coconut shells, spent liquor, coal, petroleum heavy oil, or coal/petroleum pitch obtained by thermal cracking of these materials, and resins such as a phenolic resin.

Activation is generally performed after carbonization, and examples of the activation method include a gas activation method and a chemical activation method. In the gas activation method, by performing contact reaction with water vapor, carbon dioxide, oxygen, or the like at high temperatures, activated carbon is obtained. In the chemical activation method, the raw materials described above are impregnated with a known chemical activation agent, by heating in an inert gas atmosphere, dehydration and oxidation reaction of the chemical activation agent are caused, and thereby activated carbon is obtained. As the chemical activation agent, for example, zinc chloride, sodium hydroxide, or the like may be used.

The particle size of activated carbon is not limited to, but is preferably 20 μm or less. The specific surface of activated carbon is not limited to, but is preferably about 800 to 3,000 m²/g. By setting the specific surface in this range, the electrostatic capacity of the LIC can be increased, and the internal resistance can be decreased.

(b) Conductive Aid

The type of conductive aid is not particularly limited, and a known or commercially available conductive aid can be used. Examples thereof include acetylene black, Ketjen black, carbon fibers, natural graphite (flaky graphite, earthy graphite, and the like), artificial graphite, and ruthenium oxide. Among these, acetylene black, Ketjen black, carbon fibers, and the like are preferable. This can improve electrical conductivity of the LIC. The content of the conductive aid is not limited to, but is preferably about 0.1 to 10 parts by mass relative to 100 parts by mass of activated carbon. When the content exceeds 10 parts by mass, there is a concern that electrostatic capacity may decrease.

(c) Binder

The type of binder is not particularly limited, and a known or commercially available binder can be used. Examples thereof include polyvinylidene fluoride, polytetrafluoroethylene, polyvinyl pyrrolidone, polyvinyl chloride, polyolefin, styrene-butadiene rubber, polyvinyl alcohol, and carboxymethylcellulose. From the viewpoint of adhesion between the active material and the current collector, polyvinylidene fluoride, polyvinyl pyrrolidone, polyvinyl chloride, styrene-butadiene rubber, polyvinyl alcohol, and polyimide are preferable. On the other hand, from the viewpoint of heat resistance, polytetrafluoroethylene, polyolefin, carboxymethylcellulose, and polyimide are preferable.

The content of the binder is not particularly limited, but is preferably 0.5 to 10 parts by mass relative to 100 parts by mass of activated carbon. By setting the content in this range, it is possible to improve binding strength while suppressing an increase in electrical resistance and a decrease in electrostatic capacity.

2. Negative Electrode

(1) General Description

A negative electrode includes a negative electrode current collector composed of a metal foil or a metal porous body and is produced, for example, by a method in which a negative electrode active material paste mainly composed of a negative electrode active material, such as a carbon material, capable of occluding and desorbing lithium ions is applied onto the metal foil by a doctor blade process or the like, or a method in which the negative electrode active material paste is filled into the metal porous body by an injection process or the like. Furthermore, as necessary, after drying, pressure forming may be performed with a roller press or the like.

In order to occlude lithium ions in the negative electrode active material, for example, a method may be used in which a Li foil is pressure-bonded to the negative electrode produced through the steps described below, and an assembled cell (LIC) is kept warm in a thermostat oven at 60° C. for 24 hours. Other examples include a method in which the negative electrode active material and a lithium material are mixed by mechanical alloying, and a method in which Li metal is incorporated into the cell, and the negative electrode and the Li metal are short-circuited.

(2) Negative Electrode Current Collector

From the viewpoint of electrical resistance, a metal foil or a metal porous body can be used as the negative electrode current collector. Such a metal is, for example, preferably, any one of Al, Cu, Ni, and stainless steel. In particular, use of an Al porous body is preferable from the viewpoint of reduction in weight of the LIC. On the other hand, from the viewpoint of electrical conductivity, a Cu porous body is preferable.

(3) Negative Electrode Active Material Paste

The negative electrode active material paste is obtained, for example, by adding a negative electrode active material capable of occluding and desorbing lithium ions into a solvent and stirring with a mixer. As necessary, a conductive aid and a binder may be incorporated thereinto.

(a) Negative Electrode Active Material

The negative electrode active material is not particularly limited as long as it is capable of occluding and desorbing lithium ions. A negative electrode active material having a theoretical capacity of 300 mAh/g or more is preferable from the viewpoint of sufficiently securing a difference from the positive electrode capacity and increasing the voltage of the LiC. Specific examples of the negative electrode active material include carbon materials, such as graphite-based materials, graphitizable carbon materials, and non-graphitizable carbon materials.

Furthermore, as the negative electrode active material, silicon (Si), a tin-based material, or lithium titanium oxide may be used. Si and a tin-based material can be preferably used when the negative electrode current collector is composed of a Ni or Cu porous body. Lithium titanium oxide can be preferably used when the negative electrode current collector is composed of an Al porous body.

(b) Conductive Aid

As the conductive aid, a known or commercially available conductive aid can be used as in the case of the positive electrode active material. That is, examples thereof include acetylene black, Ketjen black, carbon fibers, natural graphite (flaky graphite, earthy graphite, and the like), artificial graphite, and ruthenium oxide.

(c) Binder

The type of binder is not particularly limited, and a known or commercially available binder can be used as in the case of the positive electrode active material. Examples thereof include polyvinylidene fluoride, polytetrafluoroethylene, polyvinyl pyrrolidone, polyvinyl chloride, polyolefin, styrene-butadiene rubber, polyvinyl alcohol, carboxymethylcellulose, and polyimide. From the viewpoint of adhesion between the active material and the current collector, polyvinylidene fluoride, polyvinyl pyrrolidone, polyvinyl chloride, styrene-butadiene rubber, polyvinyl alcohol, and polyimide are preferable. On the other hand, from the viewpoint of heat resistance, polytetrafluoroethylene, polyolefin, carboxymethylcellulose, and polyimide are preferable.

3. Nonaqueous Electrolyte

(1) General Description

Since the LIC according to the present invention includes lithium, it is necessary to use a nonaqueous electrolyte as the electrolyte. As such a nonaqueous electrolyte, for example, an electrolyte prepared by dissolving a lithium salt required for charging and discharging in an organic solvent can be used.

(2) Lithium Salt

As the lithium salt, from the viewpoint of solubility in a solvent, for example, LiClO₄, LiBF₄, LiPF₆, or the like can be preferably used. These may be used alone or two or more of them may be mixed for use.

(3) Solvent

As the solvent that dissolves the lithium salt, from the viewpoint of ionic conductivity, for example, at least one selected from the group consisting of ethylene carbonate, propylene carbonate, butylene carbonate, dimethyl carbonate, diethyl carbonate, and ethyl methyl carbonate can be preferably used.

4. Separator

As the separator, a known or commercially available separator can be used. For example, an insulating film composed of polyolefin, polyethylene terephthalate, polyamide, polyimide, cellulose, glass fibers, or the like is preferable. The average pore diameter of the separator is not particularly limited, and is usually about 0.01 to 5 μm. The average thickness is usually about 10 to 100 μm.

5. Assembly of LIC

An LIC according to the present invention can be produced by a method in which the positive electrode is paired with the negative electrode, a separator is arranged between the two electrodes, and a nonaqueous electrolyte containing a lithium salt is impregnated into the two electrodes and the separator.

In the LIC, by causing the negative electrode to occlude (to be predoped with) lithium ions by a chemical or electrochemical method, the potential of the negative electrode is decreased, and the voltage can be increased. Since energy is proportional to the square of the voltage, an LIC having high energy is produced.

In this case, preferably, the negative electrode capacity is larger than the positive electrode capacity, and the amount of lithium ions occluded in the negative electrode active material is 90% or less of the difference between the positive electrode capacity and the negative electrode capacity. By restricting the capacity by the positive electrode in such a manner, it is possible to prevent short-circuiting due to lithium dendrite growth.

6. Power Storage Device and Power Storage System

The LIC obtained as described above has a sufficiently high capacity. Therefore, by connecting a plurality of such LICs in series and/or in parallel to constitute a composite device, it is possible to provide an excellent power storage device. Furthermore, by combining the LIC with an inverter and a reactor to constitute a composite system, it is possible to provide an excellent power storage system.

### EXAMPLES

The present invention will be described in more details with reference to examples. Outlines of the examples are as follows:

[1] An LIC including a positive electrode in which an Al porous body was used as a positive electrode current collector and activated carbon was used as a positive electrode active material, and a negative electrode in which a copper foil was used as a negative electrode current collector and a carbon material was used as a negative electrode active material (Example 1)

[2] An LIC including a positive electrode in which an Al porous body was used as a positive electrode current collector and activated carbon was used as a positive electrode active material, and a negative electrode in which a Ni porous body was used as a negative electrode current collector and Si was used as a negative electrode active material (Example 2)

[3] An LIC including a positive electrode in which an Al porous body was used as a positive electrode current collector and activated carbon was used as a positive electrode active material, and a negative electrode in which a Ni porous body was used as a negative electrode current collector and carbon material was used as a negative electrode active material (Example 3)

[4] An LIC including a positive electrode in which an Al porous body was used as a positive electrode current collector and activated carbon was used as a positive electrode active material, and a negative electrode in which a Ni porous body was used as a negative electrode current collector and a tin-based material was used as a negative electrode active material (Example 4)

[5] An LIC including a positive electrode in which an Al porous body was used as a positive electrode current collector and activated carbon was used as a positive electrode active material, and a negative electrode in which an Al porous body was used as a negative electrode current collector and LTO was used as a negative electrode active material (Example 5)

Description will be made on the fabrication of the LICs in Examples, and then the fabrication of LICs in Comparative Examples. Lastly, all of the LICs fabricated in Examples and Comparative Examples will be evaluated.

### <1> EXAMPLES

### [1] Example 1

### 1. Production of Positive Electrode

(1) Production of Al Porous Body (Positive Electrode Current Collector)

Using a urethane foam with a thickness of 1.4 mm, a porosity of 97%, and a cell diameter of 450 μm, an Al porous body with a thickness of 1.4 mm, a porosity of 95%, a cell diameter of 450 μm, and a coating weight of 200 g/m² was produced by the method described above. Specifically, the following procedure was used.

(a) Substrate Used

Conductivity-imparting treatment was performed by forming an Al coating film with a coating weight of 10 g/m² by sputtering on the surface of a polyurethane foam.

(b) Composition of Molten Salt Plating Bath

An AlCl₃:EMIC (aluminum chloride-1-ethyl-3-methyl imidazolium chloride)=2:1 bath (molar ratio) was used.

(c) Pretreatment

Before plating, as activation treatment, electrolysis treatment was performed in which the substrate was used as an anode (at 2 A/dm² for 1 min).

(d) Plating Conditions

The urethane foam having the conductive layer on the surface thereof, as a workpiece, was fixed on a jig having a power feeding function. Then, the jig on which the workpiece was fixed was placed in a glove box set in an argon atmosphere and at a low moisture (dew point −30° C. or lower), and immersed in a molten salt plating bath at a temperature of 40° C. The jig on which the workpiece was fixed was connected to the negative side of a rectifier, and an Al plate (purity 99.99%) as a counter electrode was connected to the positive side. Electroplating was performed under a current condition of 2 A/dm². Thereby, an Al structure in which an Al film was formed on the surface of the urethane foam was obtained.

(e) Removal by Decomposition of Urethane

The Al structure was immersed in a LiCl—KCl eutectic molten salt at a temperature of 500° C., and a negative potential of −1 V was applied thereto for 5 minutes. Bubbles were generated resulting from the decomposition of polyurethane in the molten salt. After being cooled to room temperature in air, the Al structure was cleaned with water to remove the molten salt. Thereby, an Al porous body from which the resin had been removed was obtained.

(2) Production of Positive Electrode

An activated carbon positive electrode paste was prepared by adding 2 parts by weight of Ketjen black (KB) as a conductive aid, 4 parts by weight of polyvinylidene fluoride powder as a binder, and 15 parts by weight of N-methyl pyrrolidone (NMP) as a solvent to 100 parts by weight of activated carbon powder (specific surface: 2,500 m²/g, average particle size: about 5 μm), and performing stirring with a mixer.

The activated carbon positive electrode paste was filled into the positive electrode current collector with a thickness of 1.4 mm produced as described above such that the activated carbon content was 30 mg/cm². The actual filling amount was 31 mg/cm². Next, drying was performed with a drier at 100° C. for one hour to remove the solvent. Then, pressing was performed with a roller press with a diameter of 500 mm (slit: 300 μm). Thereby, a positive electrode was obtained. The thickness after pressing was 480 μm. The resulting positive electrode had a capacity of 0.67 mAh/cm².

### 2. Production of Negative Electrode

(1) Negative Electrode Current Collector

A copper foil with a thickness of 20 μm was used as a negative electrode current collector.

(2) Production of Negative Electrode

A graphite-based negative electrode paste was prepared by adding 2 parts by weight of Ketjen black (KB) as a conductive aid, 4 parts by weight of polyvinylidene fluoride powder as a binder, and 15 parts by weight of N-methyl pyrrolidone (NMP) as a solvent to 100 parts by weight of natural graphite powder capable of occluding and desorbing lithium, and performing stirring with a mixer.

The graphite-based negative electrode paste was applied onto the copper foil using a doctor blade (gap: 400 μm). The actual coating amount was 10 mg/cm². Next, drying was performed with a drier at 100° C. for one hour to remove the solvent. Then, pressing was performed with a roller press with a diameter of 500 mm (slit: 200 μm). Thereby, a negative electrode was obtained. The thickness after pressing was 220 μm. The resulting negative electrode had a capacity of 3.7 mAh/cm².

### 3. Fabrication of Cell

The positive electrode and the negative electrode thus obtained were each cut into a size of 5 cm×5 cm. The active material was removed from a portion of each electrode. An aluminum tab lead was welded to the positive electrode, and a nickel tab lead was welded to the negative electrode. These electrodes were moved to a dry room, and were first dried at 140° C. for 12 hours in a reduced pressure environment. The two electrodes were arranged so as to face each other with a separator composed of polypropylene therebetween to constitute a single cell element, and the single cell element was placed in a cell composed of an aluminum laminate. Furthermore, a lithium electrode for predoping produced by pressure-bonding a lithium metal foil to a nickel mesh and enclosed with the separator was also placed in the cell so as not to be in contact with the single cell element. A mixture of ethylene carbonate (EC) and diethyl carbonate (DEC) at a volume ratio of 1:1, in which 1 mol/L of LiPF₆ was dissolved, serving as an electrolyte, was poured and impregnated into the electrodes and the separator. Lastly, the aluminum laminate was sealed while reducing the pressure with a vacuum sealer. Thereby, a lithium ion capacitor (LIC) of Example 1 was fabricated.

In order to perform predoping, the negative electrode was connected to the lithium electrode for predoping, and while controlling the current and time such that the predoping amount was 90% of the difference in capacity between the positive and negative electrodes, predoping was performed.

### [2] Example 2

### 1. Production of Positive Electrode

A positive electrode similar to that of Example 1 was produced.

### 2. Production of Negative Electrode

(1) Production of Negative Electrode Current Collector

A nickel foam was used as a negative electrode current collector. The nickel foam was produced by a method in which after a urethane sheet (commercial item, average pore diameter: 90 μm, thickness: 1.4 mm, porosity: 96%) was subjected to conductivity-imparting treatment, nickel plating was performed in a predetermined amount, the urethane was removed by burning in air at 800° C., and then, superheating was performed in a reducing atmosphere (hydrogen) at 1,000° C. to reduce nickel. In the conductivity-imparting treatment, 10 g/m² of nickel was deposited by sputtering. The amount of nickel plating was determined so that the total amount including the amount of the conductivity-imparting treatment was 400 g/m². The resulting nickel foam had an average pore diameter of 80 μm, a thickness of 1.2 mm, and a porosity of 95%.

(2) Production of Negative Electrode

A silicon negative electrode paste was prepared by adding 0.7 parts by weight of Ketjen black (KB) as a conductive aid, 2.5 parts by weight of polyvinylidene fluoride powder as a binder, and 75.3 parts by weight of N-methyl pyrrolidone (NMP) as a solvent to 21.5 parts by weight of silicon powder (average particle size: about 10 μm), and performing stirring with a mixer.

The silicon negative electrode paste was filled into the negative electrode current collector whose thickness had been adjusted by a roller press at a gap of 550 μm in advance such that the silicon content was 13 mg/cm². The actual filling amount was 12.2 mg/cm². Next, drying was performed with a drier at 100° C. for one hour to remove the solvent. Then, pressing was performed with a roller press with a diameter of 500 mm (gap: 150 μm). Thereby, a negative electrode was obtained. The thickness after pressing was 185 μm. The resulting negative electrode had a capacity of 47 mAh/cm².

### 3. Fabrication of Cell

Using the positive electrode and the negative electrode thus obtained, an LIC of Example 2 was fabricated as in Example 1, and then predoping of lithium was performed in the same manner. The amount of Li⁺ occluded in silicon was adjusted to be 90% of the difference between the positive electrode capacity and the negative electrode capacity.

### [3] Example 3

### 1. Production of Positive Electrode

A positive electrode similar to that of Example 1 was produced.

### 2. Production of Negative Electrode

Using a Ni porous body similar to that of Example 2 as a negative electrode current collector and a graphite-based negative electrode paste, a negative electrode was obtained as in Example 1. The thickness after pressing was 205 μm. The resulting negative electrode had a capacity of 4.2 mAh/cm².

### 3. Fabrication of Cell

Using the positive electrode and the negative electrode thus obtained, an LIC of Example 3 was fabricated as in Example 1, and then predoping of lithium was performed in the same manner. The amount of Li⁺ occluded in silicon was adjusted to be 90% of the difference between the positive electrode capacity and the negative electrode capacity.

### [4] Example 4

### 1. Production of Positive Electrode

A positive electrode similar to that of Example 1 was produced.

### 2. Production of Negative Electrode

(1) Negative Electrode Current Collector

A Ni porous body similar to that of Example 2 was used as a negative electrode current collector.

(2) Production of Negative Electrode

A tin-based material negative electrode paste was prepared by adding 0.7 parts by weight of Ketjen black (KB) as a conductive aid, 2.5 parts by weight of polyvinylidene fluoride powder as a binder, and 75.3 parts by weight of N-methyl pyrrolidone (NMP) as a solvent to 21.5 parts by weight of pure tin powder, i.e., a tin-based material, (average particle size: about 12 μm), and performing stirring with a mixer.

The tin-based material paste was filled into the current collector whose thickness had been adjusted by a roller press at a gap of 550 μm in advance such that the tin-based material content was 12 mg/cm². The actual filling amount was 12.4 mg/cm². Next, drying was performed with a drier at 100° C. for one hour to remove the solvent. Then, pressing was performed with a roller press with a diameter of 500 mm (gap: 150 μm). Thereby, a negative electrode was obtained. The thickness after pressing was 187 μm. The resulting negative electrode had a capacity of 12.3 mAh/cm².

### 3. Fabrication of Cell

Using the positive electrode and the negative electrode thus obtained, an LIC of Example 4 was fabricated as in Example 1, and then predoping of lithium was performed in the same manner. The amount of Li′ occluded in silicon was adjusted to be 90% of the difference between the positive electrode capacity and the negative electrode capacity.

### [5] Example 5

### 1. Production of Positive Electrode

A positive electrode similar to that of Example 1 was produced.

### 2. Production of Negative Electrode

(1) Negative Electrode Current Collector

As a negative electrode current collector, an Al porous body similar to that used as the positive electrode current collector in Example 1 was used.

(2) Production of Negative Electrode

An LTO negative electrode paste was prepared by adding 3 parts by weight of Ketjen black (KB) as a conductive aid, 3 parts by weight of polyvinylidene fluoride powder as a binder, and 41 parts by weight of N-methyl pyrrolidone (NMP) as a solvent to 53 parts by weight of LTO powder (average particle size: about 8 μm), and performing stirring with a mixer.

The LTO paste was filled into the current collector whose thickness had been adjusted by a roller press at a gap of 550 μm in advance such that the LTO content was 15 mg/cm². The actual filling amount was 15.3 mg/cm². Next, drying was performed with a drier at 100° C. for one hour to remove the solvent. Then, pressing was performed with a roller press with a diameter of 500 mm (gap: 150 μm). Thereby, a negative electrode was obtained. The thickness after pressing was 230 μm. The resulting negative electrode had a capacity of 2.7 mAh/cm².

### 3. Fabrication of Cell

Using the positive electrode and the negative electrode thus obtained, an LIC of Example 5 was fabricated as in Example 1, and then predoping of lithium was performed in the same manner. The amount of Li′ occluded in silicon was adjusted to be 90% of the difference between the positive electrode capacity and the negative electrode capacity.

### <2> COMPARATIVE EXAMPLES

### [1] Comparative Example 1

An aluminum foil (commercial item, thickness: 20 μm) was used as a positive electrode current collector. The positive electrode active material paste prepared in Example 1 was applied onto both surfaces by a doctor blade process such that the coating amount was 10 mg/cm² in total for both surfaces, followed by rolling. Thereby, a positive electrode was produced. The actual coating amount was 11 mg/cm², and the thickness of the electrode was 222 μm. Thereafter, the same procedure was used as in Example 1, and an LIC of Comparative Example 1 was fabricated.

### [2] Comparative Example 2

A capacitor was fabricated using a positive electrode and a negative electrode, each of which was the same as the positive electrode used in Example 1. As an electrolyte, a propylene carbonate solution in which tetraethylammonium tetrafluoroborate was dissolved at 1 mol/L was used. As a separator, a cellulose fiber separator (thickness: 60 μm, density: 450 mg/cm³, porosity: 70%) was used.

### <3> Evaluation Results of Capacitors

Ten capacitors were fabricated in the same manner for each of Examples 1 to 5 and Comparative Examples 1 and 2. Evaluation was performed in the voltage ranges (described in Table) which were determined depending on combinations of the active materials used. Charging was performed at 2 mA/cm² for 2 hours, discharging was performed at 1 mA/cm², and the initial capacity and the energy density were obtained. The volume on which the energy density was based was defined as the volume of the electrode stacked body in the cell, and was calculated from the expression:

(thickness of positive electrode+thickness of separator+thickness of negative electrode)×electrode area.

The average values are shown in Table.

| | TABLE | | |
|---|---|---|---|
| | Item | | |
| | Operating | Initial | Energy |
| | voltage range | capacity | density |
| Units of measure | (V) | (mAh) | (Wh/L) |
| Example 1 | 2.5~4.2 | 15.4 | 30.2 |
| Example 2 | 2.5~4.2 | 15.3 | 31.6 |
| Example 3 | 2.5~4.2 | 15.2 | 30.8 |
| Example 4 | 2.5~4.2 | 15.3 | 31.5 |
| Example 5 | 1.5~2.7 | 11.3 | 29.8 |
| Comparative | 2.5~4.2 | 5.5 | 16.2 |
| Example 1 | | | |
| Comparative | 2.5~4.2 | 22.3 | 12.2 |
| Example 2 | | | |

As is evident from Table, in the LICs (Examples 1 to 5) in which the Al porous body was used as the positive electrode current collector, the initial capacity is large and the energy density is also large in comparison with the LIC (Comparative Example 1) in which the Al foil was used as the positive electrode current collector. Furthermore, it is evident that the energy density is large in comparison with the capacitor (Comparative Example 2) in which doping of lithium was not performed.

The present invention has been described on the basis of embodiments. It is to be noted that the present invention is not limited to the embodiments described above, and various modifications can be made to the embodiments described above within the scope that is the same as and equivalent to that of the present invention.

### REFERENCE SIGNS LIST

1 resin foam
2 Al layer
3 Al porous body

1. A lithium ion capacitor comprising:
a positive electrode including a positive electrode active material mainly composed of activated carbon and a positive electrode current collector;
a negative electrode including a negative electrode active material capable of occluding and desorbing lithium ions and a negative electrode current collector; and
a nonaqueous electrolyte containing a lithium salt,
characterized in that the positive electrode current collector is an aluminum porous body having a three-dimensional structure, the positive electrode active material is filled into the positive electrode current collector, and the negative electrode current collector is a metal foil or a metal porous body.

2. The lithium ion capacitor according to claim 1, characterized in that the positive electrode current collector is an aluminum porous body having a three-dimensional structure in which the coating weight is 80 to 1,000 g/m² and the pore diameter is 50 to 1,000 μm.

3. The lithium ion capacitor according to claim 1, characterized in that the negative electrode active material is mainly composed of a carbon material.

4. The lithium ion capacitor according to claim 3, characterized in that the carbon material is any one of graphite, graphitizable carbon, and non-graphitizable carbon.

5. The lithium ion capacitor according to claim 1, characterized in that the negative electrode active material is mainly composed of any one of silicon, tin, and lithium titanium oxide.

6. The lithium ion capacitor according to claim 1, characterized in that the negative electrode current collector is composed of any one of aluminum, copper, nickel, and stainless steel.

7. The lithium ion capacitor according to claim 1, characterized in that the lithium salt is at least one selected from the group consisting of LiClO₄, LiBF₄, and LiPF₆; and a solvent of the nonaqueous electrolyte is at least one selected from the group consisting of ethylene carbonate, propylene carbonate, butylene carbonate, dimethyl carbonate, diethyl carbonate, and ethyl methyl carbonate.

8. The lithium ion capacitor according to claim 1, characterized in that the capacity of the negative electrode per unit area (negative electrode capacity) is larger than the capacity of the positive electrode per unit area (positive electrode capacity), and the amount of lithium ions occluded in the negative electrode active material is 90% or less of the difference between the positive electrode capacity and the negative electrode capacity.

9. A power storage device characterized in that a plurality of lithium ion capacitors, each being the lithium ion capacitor according to claim 1, are assembled in series and/or in parallel into a composite device.

10. A power storage system characterized in that the lithium ion capacitor according to claim 1 is combined with an inverter and/or a reactor to constitute a composite system.
